(19) United States
(12) Patent Application Publication
(10) Pub. No.: US 2013/0077646 A1
(43) Pub. Date: Mar. 28, 2013

(54) AUTOMATIC MODULATION CONTROL FOR MAINTAINING CONSTANT EXTINCTION RATIO (ER), OR CONSTANT OPTICAL MODULATION AMPLITUDE (OMA) IN AN OPTICAL TRANSCEIVER

(71) Applicants: Jiaxi Kan, San Jose, CA (US); David Hui, Santa Clara, CA (US); Steven Fong, Oakland, CA (US)

(72) Inventors: Jiaxi Kan, San Jose, CA (US); David Hui, Santa Clara, CA (US); Steven Fong, Oakland, CA (US)

(21) Appl. No.: 11/864,207

(22) Filed: Sep. 28, 2007

(51) Int. Cl. H01S 3/00

(52) U.S. Cl. CPC H01S 3/0014
USPC 372/38.02

(57) ABSTRACT

To a laser that has no tracking error a desired laser modulation current to maintain constant Optical Modulation Amplitude (OMA) is closely proportional to the laser bias current, lb, at any temperature when the laser is under constant power according to embodiments. To a laser that has tracking error a desired laser modulation current to maintain constant Optical Extension Ratio (ER) is closely proportional to the laser bias current, lb, at any temperature when the laser is under constant power according to embodiments. This phenomenon is appears apply to many if not all types of lasers. A laser modulation control is provided that determines a modulation current based on the laser bias current. Thus, embodiments may maintain performance and compensate for temperature changes without the need to actually measure temperature thereby eliminating the need for temperature sensors and their associated parameter vs. temperature look-up tables or dithering techniques used in the past.

### FIELD OF THE INVENTION

Embodiments of the present invention relate to laser control and, more particularly, to controlling a laser operating in various temperatures without measuring temperature.

### BACKGROUND INFORMATION

In a typical optical transponder or transceiver, a laser is used as the optical signal source. Lasers tend to be very sensitive to temperature and its slope efficiency and current threshold change with temperature. Typically, laser operation may be controlled by an APC (Automatic Power Control) circuitry to maintain constant optical power over temperature. But in the case of high speed data rate transceivers, such as 10 Gb transceivers (especially for 10 Gb Ethernet and 10 Gb SONET), one would like to maintain constant OMA (Optical Modulation Amplitude) or in the least maintain constant ER (Extension Ratio).

A conventional approach for controlling constant OMA, is to map the temperature dependence of the modulation and perform a table lookup based on the temperature sensed with a microcontroller. This technique requires several hours of calibration and have very high manufacture cost.

Another scheme is to dither the bias and/or the modulation current to detect the slope efficiency of the laser. But the dither signal introduces penalty for the optical signal quality such as mask margin performance and, in cases like Vertical Cavity Surface Emitting Laser (VCSEL) or Fabry Perot Laser (FP), the connector back-reflection prevents the proper use to the dither signal.

Thus it may be beneficial to control laser modulation based on the laser parameters (i.e. no external temperature or dither signal is required).

### BRIEF DESCRIPTION OF THE DRAWINGS

The foregoing and a better understanding of the present invention may become apparent from the following detailed description of arrangements and example embodiments and the claims when read in connection with the accompanying drawings, all forming a part of the disclosure of this invention. While the foregoing and following written and illustrated disclosure focuses on disclosing arrangements and example embodiments of the invention, it should be clearly understood that the same is by way of illustration and example only and the invention is not limited thereto.

FIG. 1 is a graph showing an example of a laser bias current verses desired modulation current for a DFB laser according to embodiments of the invention;

FIG. 2 is a block diagram showing a dual loop control (DLC) for controlling laser bias current and modulation current according to embodiments of the invention; and

FIG. 3 is a flow diagram showing implementation of automatic modulation control for a laser including tracking error correction, life aging correction, and end of life detection.

### DETAILED DESCRIPTION

In the following detailed description, like reference numerals and characters may be used to designate identical, corresponding or similar components in differing FIG. drawings. Well-known power/ground connections to integrated circuits (ICs) and other components may not be shown within the figures for simplicity of illustration and discussion. Where specific details are set forth in order to describe example embodiments of the invention, it should be apparent to one skilled in the art that the invention can be practiced without these specific details.

While lasers may be very sensitive to temperature, embodiments relate to maintaining performance and compensating for temperature changes without the need to actually measure temperature thus eliminating the need for temperature sensors and their associated parameter vs. temperature look-up tables or dithering techniques used in the past.

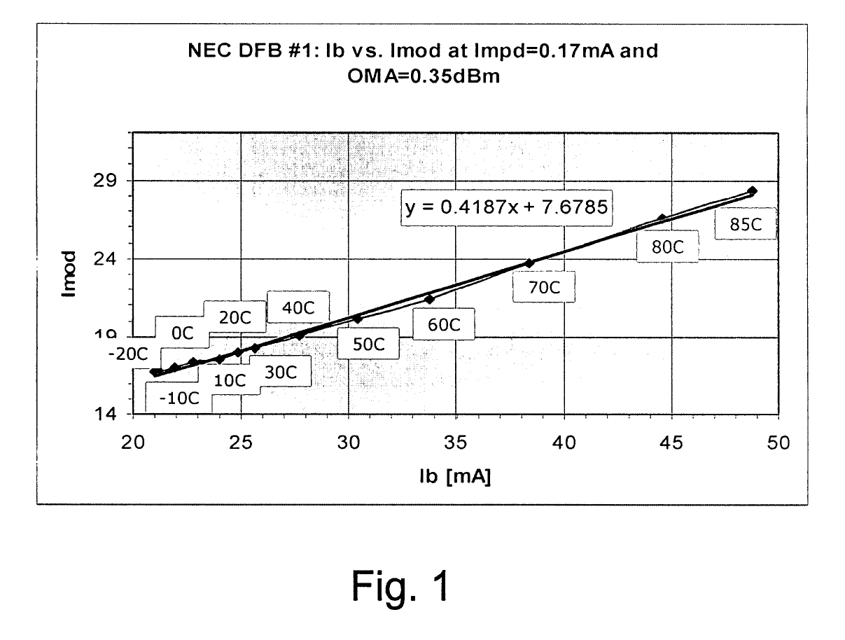

Referring now to FIG. 1, there is shown a table plotting laser bias current (l_{b} mA) verses desired modulation current (l_{mod} mA). It has been discovered by experiment and simulation that a desired laser modulation current to maintain constant Extension Ratio (ER) and constant Optical Modulation Amplitude (OMA) is closely proportional to the laser bias current, lb, at any temperature when the laser is under constant power and assuming no tracking error.

As shown in FIG. 1, for temperatures ranging from −20° C. to +85° C., to a laser that has no tracking error (TE), the laser modulation current (l_{mod}) required to maintain average optical power (AOP) and optical modulation amplitude (OMA) linearly tracks very closely the laser bias current (lb); or to a laser that has tracking error (TE), the laser modulation current (l_{mod}) required to maintain optical extension ratio (ER) linearly tracks very closely the laser bias current (lb). Here the linear relationship Y=K1*X+K2 may be described mathematically as lmod=K1*(lb)+K2, where lmod is modulation current, lb is laser bias current, and K1 and K2 are constants.

In this case for a the laser operating at OMA=0.35 dbm, the linear transfer function may be described as lmod=0.4187*(lb)+7.6785. Thus, laser bias current may now be used to calculate and control the modulation current and compensate tracking error and life aging degradation of the laser. It gives a good status indicator for the laser being controlled and enables on the fly laser calibration. Previous controlling methods based on estimating the laser status by measuring temperatures or dithering the laser operating point are not necessary.

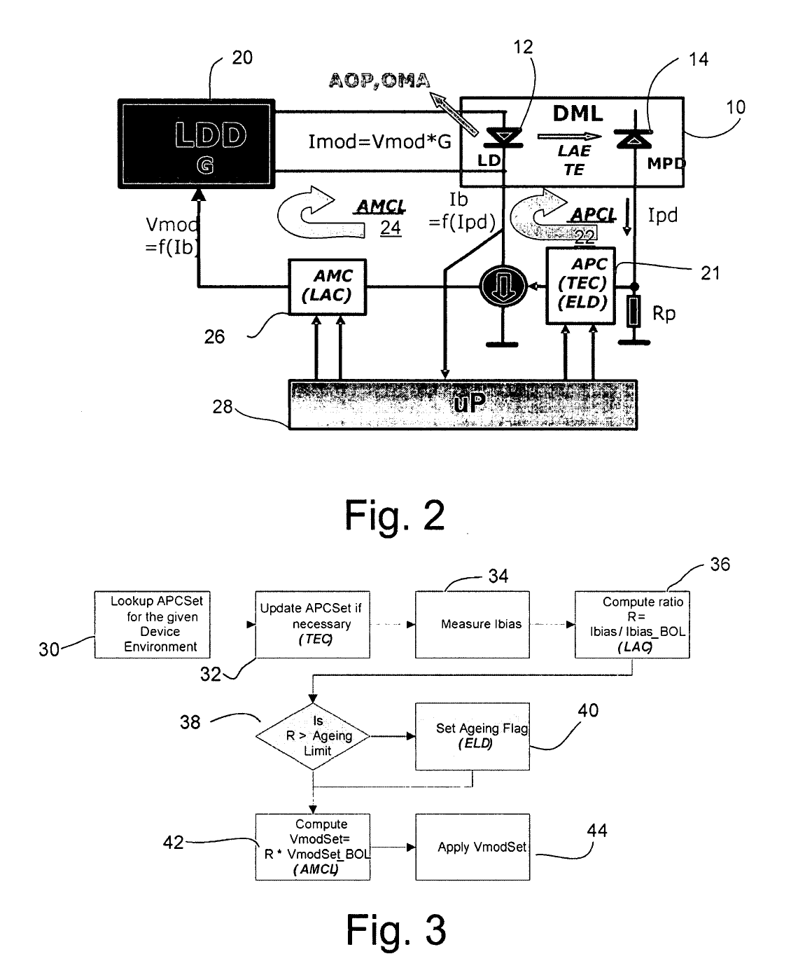

FIG. 2 shows the basic block diagram illustrating an embodiment of the invention. A direct modulation laser (DML) 10 may include a laser diode (LD) 12 and a monitor photo diode (MPD) 14 to monitor the output of the LD 12. A laser diode driver (LDD) 20 drives the LD 12. The LDD 20, among other things, seeks to maintain average optical power (AOP) and optical modulation amplitude (OMA) over a range of temperatures. An Automatic Power Control Loop (APCL) 22 may use a conventional automatic power controller (APC) 21 that uses the signal from the monitoring photo diode 14 to control the laser bias current (lb) to maintain constant optical power. The instant Automatic Modulation Control Loop (AMCL) 24 includes an auto modulation controller 26 that uses lb and the linear transfer function described above to calculate the laser modulation current. Many lasers show tracking error (TE) due to optical/mechanical parts instability over temperature. Embodiments thus include a tracking error correction (TEC) technology.

Since this relationship between bias current and modulation current at a constant power appears to apply to lasers across the board, the constants for the linear transfer function of lmod to lb can be obtained at a single temperature; over temperature may not be necessary. However, a single point calibration may not compensate minor errors such as MPD tracking errors and the small temperature instability of the laser driver. For critical applications such as IEEE802.3ae10GBase-SR which requires very small OMA variation over a large temperature range an over temperature calibration may be required. These minor errors may be stored in a lookup table and can be corrected by a microprocessor 28 or similar devices.

The conventional over temperature calibration is very time consuming and very costly, but now with the modulation control based on the lb, there is no longer a need to wait for the temperature to stabilized before calibration and calibrate the laser may be accomplished on the fly (OFC). The calibration time is now limited only by the ramp rate of the environmental chamber.

In addition, by comparing measured bias current (lb) to the bias current at the beginning of life, the ageing of the laser (reduction in slope efficiency) can be tracked and compensated (LAC). This will extend the life of the device and at the same time give an indication of health of the laser and/or determine the End of Life for the laser (ELD).

FIG. 3 shows a flow diagram illustrating automatic modulation control for a laser including tracking error correction (TEC), life aging correction (LAC), and end of life detection (ELD) which may be implemented with a microprocessor or other suitable device. In block 30, the automatic power control settings (APCSet) may be looked up for a given device environment. That is, the laser bias current (lb) may be determined based on the output of the monitor photo diode 14, shown in FIG. 2. In block 32, APCSet may be updated for any tracking error corrections by calibrating optical output power from optical fiber output power. The resultant bias current (lb) may be measured as shown in block 34. In block 36, a ratio may be computed to determine a life aging correction factor (LAC) where the ratio (R) is equal to the measured bias current (lb) over the bias current for the device at beginning of life (BOL), that is, when the device was new prior to any effects of aging. When the device is new, this ratio should be equal to one. In decision block 38, it is determined if this ratio “R” is greater than some preset limit, such as, for example 1.5. If so, then in block 40 an aging flag for end of life detection (ELD) is set to indicate that the laser should be replaced. In block 42, if the laser is not sufficiently aged, then the modulation current may be calculated based in the measured bias current from block 34 using the transfer function lmod=K1*(lb)+K2 as previously described to determine the modulation voltage VmodSet. This parameter may be adjusted based on the ratio R from block 36 to produce a corrected modulation voltage. Finally, in block 44, the modulation voltage VmodSet is applied via the laser driver.

This invention allows the user to produce optical transceivers (that use DML lasers) with high performance and reliability as well as low cost. The new DLC has demonstrated in SFP+10G SR the highest performance (with only+/−0.15 dB OMA variation over −15C to +75C and fast calibration time (a few of minutes). Further, this technique makes optical transceivers to having high optical eye stability and high quality with low cost. Tradeoff between performance and price is also available (e.g. single point versus over temperature calibration).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus for controlling a laser, comprising:
a monitor photo diode to monitor the output of a laser;
a power control loop to determine laser bias current based on the output of the monitor photo diode; and
a modulation control loop to determine the modulation current for the laser based on the laser bias current.

2. The apparatus as recited in claim 1, wherein the modulation control loop applies a linear transfer function to the laser bias current to determine the modulation current.

3. The apparatus as recited in claim 2, wherein the linear transfer function comprises lmod=K1*(lb)+K2, where lmod is modulation current, lb is laser bias current, and K1 and K2 are constants.

4. The apparatus as recited in claim 3 wherein K1 and K2 are modified based on previously stored tracking error correction (TEC) factors.

5. The apparatus as recited in claim 4 wherein a life aging correction (LAG) may be calculated by determining a ratio (R) of the measured bias current and a beginning of life (BOL) bias current.

6. The apparatus as recited in claim 5 further comprising setting an end of life flag to be set if the ratio is larger than a preset limit.

7. A method comprising:
monitoring the output of a laser with a monitor photo diode;
determining laser bias current based on the output of the monitor photo diode; and
determining laser modulation current for the laser based on the laser bias current.

8. The method as recited in claim 7, further comprising applying a linear transfer function to the laser bias current to determine the laser modulation current.

9. The method as recited in claim 8, wherein the linear transfer function comprises lmod=K1*(lb)+K2, where lmod is modulation current, lb is laser bias current, and K1 and K2 are constants.

10. The method as recited in claim 9 wherein the transfer function comprises lmod=K1*(lb)+K2, where lmod is modulation current, lb is laser bias current, K1 and K2 is calculated for a particular laser.

11. The method as recited in claim 10 wherein K1 and K2 are modified based on previously stored tracking error correction (TEC) factors.

12. The method as recited in claim 10 further comprising calculating a life aging correction (LAG) by determining a ratio (R) of the measured bias current and a beginning of life (BOL) bias current.

13. The method as recited in claim 12 further comprising setting an end of life flag if the ratio is larger than a preset limit.
